(19) United States
(12) Patent Application Publication
(10) Pub. No.: US 2021/0204569 A1
(43) Pub. Date: Jul. 8, 2021

(54) A METHOD FOR THE PRODUCTION OF A ROOM-TEMPERATURE ACIDIC BEVERAGE CONTAINING SPORIC BACILLUS COAGULANS

(71) Applicant: The Coca-Cola Company, Atlanta, GA (US)

(72) Inventors: Tushar Joshi, Atlanta, GA (US); Prahant Bhat, Mandarin City (CN)

(21) Appl. No.: 17/059,062

(22) PCT Filed: May 28, 2019
(86) PCT No.: PCT/US2019/034169

§ 371 Date: Nov. 25, 2020

(30) Foreign Application Priority Data
May 28, 2018 (CN) 201810520602.8

(51) Int. Cl. A23L 2/68; A23L 3/10; A23C 9/12; A23F 3/14; A23L 2/02

(52) U.S. Cl. CPC A23L 2/68; A23L 3/10; A23L 2/02; A23F 3/14; A23C 9/12

(57) ABSTRACT

The present invention discloses a method for the production of a room-temperature acidic beverage containing sporic Bacillus coagulans, which comprises the following steps: an acidic beverage is prepared and sterilized under sterilization conditions corresponding to 750 C to 110° C. for 23 to 33 s; sporic Bacillus coagulans is then dispersed into sterile water, and the Bacillus coagulans solution thus obtained is pasteurized under pasteurization conditions corresponding to 70 to 90° C. for 23 to 33 s; the acidic beverage obtained following sterilization and the sporic Bacillus coagulans solution obtained following pasteurization are placed in canned packaging to obtain a room-temperature acidic beverage containing sporic Bacillus coagulans. By employing a two-step sterilization process, said method ensures that the concentration of active sporic Bacillus coagulans conforms to relevant standards while maintaining the stability of the acidic beverage, and significantly extends the shelf-life of the acidic beverage.

### CROSS REFERENCE TO RELATED APPLICATION

The present application claims priority to Chinese Patent Application No. 201810520602.8, filed May 28, 2018, which is incorporated herein by reference in its entirety.

### TECHNICAL FIELD

The present invention relates to the technical field of beverage preparation. More specifically, it relates to a method for the production of a room-temperature acidic beverage containing sporic Bacillus coagulans.

### BACKGROUND ART

Probiotics refer to active microorganisms beneficial to the host and the term probiotic is a general term used to refer to active beneficial microorganisms that colonize the human intestine and reproductive system and can produce identifiable health benefits, improving the balance of the host's microbial biome and serving a beneficial role. When a given human body contains sufficient probiotics, the corresponding person will be in a healthy state. Once the microflora inside of a body are out of balance, such as when the proportion of different microbial species changes greatly or exceeds a normal range, the corresponding person will face a series of diseases such as diarrhea, allergies, poor appetite, fatigue, and low immunity and the health of the human body itself will be adversely affected. In the above case, proper consumption of foods containing probiotics can help to balance the microflora contained in the body, restoring health. However, most probiotic species do not form spores, resulting in poor acid and heat tolerance and the inability to use such species in heated foods or heated acidic beverages.

Inserting probiotics into a beverage makes it possible to not only replenish the body's water supply but also simultaneously replenish probiotics required by the body. Currently, fermented beverages sold on the commercial market are classified as either sterile (non-live) beverages or non-sterilized (live) beverages. Sterile (non-live) beverages do not contain active probiotics. Non-sterilized beverages are blended and prepared directly from fermented milk. Since sterilization is not performed following blending, contamination by microorganisms readily occurs during the blending and filling process, despite the fact that all other raw ingredients are subject to sterilization following dissolution and mixing. Therefore, non-sterilized beverages must be stored and transported at low temperatures and have a short shelf-life of typically only 3 to 30 days when stored at 2 to 10° C.

Section 2, Article 10 of the “Regulations Pertaining to the Evaluation and Approval of Probiotic Health Foods” clearly states: “the production of probiotics and probiotic health food products in liquid form is not recommended.” The aforementioned policy guidelines, as well as restrictions on production processes and product characteristics, have limited the use of probiotics in room-temperature acidic beverages, such that there are currently no long-shelf-life beverages containing active probiotics sold on the commercial market.

Bacillus coagulans is an important species of probiotic which belongs to the family of facultative anaerobic bacteria; it can grow in both aerobic and anaerobic environments and can adapt to a hypoxic intestinal environment, shows relatively high acid and bile tolerance, is capable of lactic acid fermentation, produces L-lactic acid which lowers intestinal pH, inhibits harmful bacteria, and promotes the growth and reproduction of beneficial bacteria such as bifidobacteria. Bacillus coagulans is capable of forming spores and is beneficial for restoring the micro-ecological balance of the gastrointestinal tract compared to other lactic acid-free Bacillus species. Bacillus coagulans are capable of germinating in the human body in about 4 to 6 hours, and 85% of bacteria can pass through the digestive system and eventually germinate and reproduce in the intestine. Sporic Bacillus coagulans have already been found to retain their viability prior to consumption as the spores are thermostable and can survive in gastric secretions, and when deposited in the intestine will produce sufficient amounts of lactic acid and other substances that antagonistically inhibit the growth of pathogenic bacteria. Currently, Bacillus coagulans are already in use in low-water content foods such as biscuits, candies, etc., but due to limitations in production processes, etc. studies have yet to be conducted regarding the use of Bacillus coagulans in long-shelf-life drinks.

Thus, there is a need to provide a method for the application of Bacillus coagulans in room-temperature acidic beverages.

### SUMMARY OF THE INVENTION

The first object of the present invention is the provision of a method for the production of a room-temperature acidic beverage containing sporic Bacillus coagulans, where, by employing a two-step sterilization process, said method ensures that the concentration of active sporic Bacillus coagulans conforms to relevant standards while the acidic beverage is subject to sufficient sterilization to effectively maintain the stability of the acidic beverage and significantly extend the shelf-life of the acidic beverage.

The second object of the present invention is the provision of a room-temperature acidic beverage containing sporic Bacillus coagulum, wherein said room-temperature acidic beverage shows high stability and can be stored on a shelf at room temperature.

Per the first object of the present invention, the present invention provides a method for the production of a room-temperature acidic beverage containing sporic Bacillus coagulans, which comprises the following steps: An acidic beverage is prepared and sterilized under sterilization conditions corresponding to 75° C. to 110° C. for 23 to 33 s;

Sporic Bacillus coagulans is then dispersed into sterile water, and the Bacillus coagulans solution thus obtained is pasteurized under pasteurization conditions corresponding to 70 to 90° C. for 23 to 33 s; where said pasteurization conditions should preferably correspond to 75 to 78° C. for 27 to 33 s;

The acidic beverage obtained following sterilization and the sporic Bacillus coagulans solution obtained following pasteurization are mixed together and placed in canned packaging to obtain a room-temperature acidic beverage containing sporic Bacillus coagulans.

Bacillus coagulans is a type of facultative anaerobic bacteria which can grow in both aerobic and anaerobic environments, can adapt to a hypoxic intestinal environment, and shows relatively high acid and bile tolerance. The bacteria is capable of lactic acid fermentation, produces L-lactic acid which lowers intestinal pH, inhibits harmful bacteria, and promotes the growth and reproduction of beneficial bacteria such as bifidobacteria. Bacillus coagulans is capable of forming spores and is beneficial for restoring the micro-ecological balance of the gastrointestinal tract compared to other lactic acid-free Bacillus species as well as promoting the health of individuals who consume it. Because Bacillus coagulans can form spores, sporic Bacillus coagulans shows strong heat and acid resistance characteristics compared to other common probiotics.

In the present invention, powdered Bacillus coagulans is dispersed into sterile water, on the one hand improving the dispersibility of the bacteria in the product, while on the other hand a Bacillus coagulans solution in liquid form can be subjected to pasteurization, preferably at a bacterial stock to water ratio of 1:5.

By using the Bacillus coagulans pasteurization conditions specified in the present invention to perform pasteurization of a Bacillus coagulans solution, it is possible to first sufficiently sterilize an acidic beverage using a relatively high temperature and then independently treat the Bacillus coagulans solution at a lower temperature, and after placement in canned packaging is complete observe the complete survival of the Bacillus coagulans culture or only suffer a 0.2 log reduction. According to international standards, at the finished product stage an active lactic acid beverage must contain 1×10⁶ cfu/ml to 1×10¹² cfu/ml of active bacteria. By using the method for the addition of sporic Bacillus coagulans provided by the present invention, it is possible to still satisfy active bacteria content standards even after sterilization is performed, provided the initial concentration of Bacillus coagulans added is suitable.

Furthermore, because relatively complete sterilization of the acidic beverage is achieved, a room-temperature acidic beverage obtained via the addition method constituted by the present invention can be stored stably at room temperature for at least six months and has a relatively long shelf-life.

It should be noted that in the context of the present invention room-temperature refers to an environment in which the temperature does not exceed 28° C.

Preferably, said room-temperature acidic beverage should correspond to a room-temperature yogurt, juice, flavored water, juice-based tea beverage or sports beverage or may correspond to any other acidic beverage to which sporic Bacillus coagulans can be added.

Preferably, given the acidic tolerance of sporic Bacillus coagulans, in the context of the present invention, the pH of the room-temperature acidic beverage should range from 2.0 to 4.4, and more preferably the pH value of said room-temperature acidic beverage should range from 3.7 to 4.3.

Preferably, in a specific embodiment of the present invention, when the initial concentration of sporic Bacillus coagulans added to said room-temperature acidic beverage corresponds to 1×10⁷ cfu/ml, it should be ensured that the concentration of sporic Bacillus coagulans does not fall under 10⁶ cfu/ml within 6 months at a temperature of 28° C.

Preferably, the method used to place the acidic beverage obtained following sterilization and the sporic Bacillus coagulans solution obtained following pasteurization into canned packaging should include sterile filling or hot filling.

Preferably, in said sterile filling method the acidic beverage obtained following sterilization and the sporic Bacillus coagulans solution obtained following pasteurization should be subject to in-line mixing. Preferably, said hot filling method should be performed at a filling temperature of 70 to 88° C. and a double filling machine should be used to place the acidic beverage obtained following sterilization and the sporic Bacillus coagulans solution obtained following pasteurization into canned packaging.

Preferably, the method used for the production of said room-temperature acidic beverage should also involve performing in-container pasteurization following hot filling, where sterilization is performed at 72° C. for 180 s or 65° C. for 600 s. In-container pasteurization can further kill other microorganisms which have contaminated the product during the production process, enhancing the stability of said room-temperature acidic beverage.

Per the second object of the present invention, the present invention also provides a room-temperature acidic beverage containing sporic Bacillus coagulans, which is prepared via a method for the production of a room-temperature acidic beverage such as that specified above. Pathogenic bacteria in said room-temperature acidic beverage can be effectively removed, leaving a pleasant texture and providing benefits to the health of the drinker.

The merits of the present invention are as follows: The present invention provides a method for the addition of sporic Bacillus coagulans to a room-temperature acidic beverage, wherein a suitable amount of sporic Bacillus coagulans is initially added as part of said method, and, by employing a two-step sterilization process, said method ensures that the concentration of active sporic Bacillus coagulans conforms to relevant standards while the acidic beverage is subject to sufficient sterilization to eliminate any harmful bacteria contaminating the beverage during production and effectively maintain the stability of the acidic beverage and significantly extend the shelf-life of the acidic beverage without affecting the flavor and texture of the acidic beverage. The invention also provides an acidic beverage prepared via said addition method, wherein said beverage has a favorable texture and good stability and can be stored on a shelf at room temperature for at least 6 months.

### SPECIFIC EMBODIMENTS

In order to more clearly illustrate the present invention, the present invention will be further described below in conjunction with corresponding preferred embodiments. It should be understood by any person skilled in the art that the following detailed description is intended to be illustrative and not restrictive and should not be construed as limiting the protective scope of the present invention.

The inventors of the present invention applied the method for adding Bacillus coagulans constituted by the present invention to long-shelf-life acidic beverages of differing viscosities and textures, including applications in yogurt, acidic dairy and yogurt beverages (with or without juice). Said products ranged in pH from 3.7 to 4.3, with protein content ranging from 0.5 to 2.7% and fat content ranging from 0.5 to 2.7%. For the examples and comparative examples included in the present invention, testing was performed on spore-type Bacillus coagulans provided by two different suppliers.

The initial amounts of Bacillus coagulans added in the following examples and comparative examples are shown in Table 1.

### EXAMPLE 1

### 1. Raw Materials

Long-shelf-life yogurt (containing 2.7% protein), Bacillus coagulans, sterile water.

### 2. Method

2.1. An environmentally long-shelf-life yogurt was sterilized at 75° C. for 25 s.
2.2. Bacillus coagulans was dispersed in sterile water (at a bacterial stock to water ratio of 1:5) and the solution was pasteurized at 75° C. for 25 s.
2.3. Sterile yogurt obtained in Step 2.1 and the Bacillus coagulans solution obtained in Step 2.2 were subject to in-line mixing and sterilely fed into canned packaging to obtain a finished yogurt product containing Bacillus coagulans.

### 3. Results

Since long-shelf-life yogurt itself contains only a small number of microorganisms, it can be fully sterilized at 75° C. for 25 s. The Bacillus coagulans-containing long-shelf-life yogurt produced via the method described here exhibited a pleasant texture and mouthfeel. Testing showed no logarithmic reduction in the Bacillus coagulans count of the final product.

### EXAMPLE 2

### 1. Raw Materials

Yogurt drink containing a yogurt base (containing 2.0% protein), Bacillus coagulans, sterile water.

### 2. Method

2.1. The yogurt drink was prepared and subject to sterilization at a temperature of 110° C. for 30 s.
2.2. Bacillus coagulans was dispersed in sterile water (at a bacterial stock to water ratio of 1:5) which was pasteurized at temperature of 88° C. for 30 s.
2.3. The solution obtained in the aforementioned two steps was subject to hot filling at a temperature of 88° C. to obtain a final yogurt drink product.

### 3. Results

The yogurt drink containing Bacillus coagulans exhibited a favorable texture and mouthfeel. Testing showed a 0.2 log reduction in Bacillus coagulans in the final product.

### EXAMPLE 3

### 1. Raw Materials

Flavored yogurt drink (containing 1.0% protein), Bacillus coagulans, sterile water.

### 2. Method

2.1. The flavored yogurt drink was prepared and subject to sterilization at a temperature of 110° C. for 30 s.
2.2. Bacillus coagulans was dispersed in sterile water (at a bacterial stock to water ratio of 1:5) which was pasteurized at temperature of 78° C. for 30 s.
2.3. The solution obtained in the aforementioned two steps was subject to hot filling at a temperature of 78° C.
2.4. Secondary in-container pasteurization was performed at a temperature of 65° C. for 600 s to obtain a finished flavored yogurt drink product.

### 3. Results

The flavored yogurt drink containing Bacillus coagulans exhibited a favorable texture and mouthfeel. Testing showed no logarithmic reduction in Bacillus coagulans of the final product.

### EXAMPLE 4

### 1. Raw Materials

Yogurt drink containing a yogurt base (containing 2.0% protein), Bacillus coagulans, sterile water.

### 2. Method

2.1. The yogurt drink containing a yogurt base (containing 2.0% protein) was prepared and subject to pasteurization at a temperature of 110° C. for 30 s.
2.2. Bacillus coagulans was dispersed in sterile water (at a bacterial stock to water ratio of 1:5) which was pasteurized at temperature of 78° C. for 30 s.
2.3. The solution obtained in the aforementioned two steps was subject to hot filling at a temperature of 78° C.
2.4. In-container pasteurization was performed at 72° C. for 180 s to obtain a finished yoghurt product containing a yogurt base.

### 3. Results

The yogurt drink containing Bacillus coagulans exhibited a favorable texture and mouthfeel. Testing showed no logarithmic reduction in Bacillus coagulans of the final product.

### COMPARATIVE EXAMPLE 1

### 1. Raw Materials

Yogurt drink containing a yogurt base (containing 2.0% protein), Bacillus coagulans, sterile water.

### 2. Method

2.1. Bacillus coagulans was added to a yogurt drink containing a yogurt base (containing 2.0% protein) to obtain a homogeneous product with a Bacillus coagulans concentration of 1×10⁷ cfu/ml.
2.2. The homogeneous product obtained in the previous step was sterilized at a temperature of 110° C. for 30 s and hot filling was performed.

### 3. Results

The sterilized yogurt drink exhibited a favorable texture and mouthfeel. However, testing showed a 7 log reduction in Bacillus coagulans in the final product.

### COMPARATIVE EXAMPLE 2

### 1. Raw Materials

Flavored yogurt drink (containing 1.0% protein), Bacillus coagulans, sterile water.

### 2. Method

2.1. Bacillus coagulans was added to a flavored yogurt drink (containing 1.0% protein) to obtain a homogeneous product with a Bacillus coagulans concentration of 1×10⁷ cfu/ml.
2.2. The homogeneous product obtained in the previous step was sterilized at a temperature of 110° C. for 30 s and hot filling was performed.

### 3. Results

The sterilized yogurt product exhibited a favorable texture and mouthfeel. However, testing showed a 7 log reduction in Bacillus coagulans in the final product.

### TEST EXAMPLES

The inventors of the present invention tested the maximum viability of Bacillus coagulans in the acidic beverages obtained in the examples and comparative examples, and the test results are shown in the following table.

TABLE 1
Testing the maximum viability of Bacillus coagulans
in each of the examples and comparative examples

| | | | | Conc. of | |
|---|---|---|---|---|---|
| | Initial | | | Bacillus | |
| | Conc. of | | Survival of | coagulans | |
| | Bacillus | Bacillus | Bacillus | in Finished | |
| | coagulans | coagulans | coagulans | Product after | Stability of |
| | Added | Sterilization | Following | Sterilization | Bacillus |
| Product | (cfu/ml) | Conditions | Sterilization | (cfu/ml) | coagulans |
| Example 1 | 3.0 × 10⁶ | 75° C./25 s | No | 3.0 × 10⁶ | Stable for |
| | | | logarithmic | | 6 months |
| | | | reduction | | at 10° C. |
| | | | | | and 28° C.; |
| | | | | | reduction |
| | | | | | of 3 log |
| | | | | | cfu/ml |
| | | | | | observed |
| | | | | | at 38° C. |
| Example 2 | 5.8 × 10^{6.2} | 88° C./30 s | Reduction of | 5.8 × 10⁶ | Stable for |
| | | | 0.2 log | | 6 months |
| | | | cfu/ml | | at 10° C. |
| | | | | | and 28° C.; |
| | | | | | reduction |
| | | | | | of 6 log |
| | | | | | cfu/ml |
| | | | | | observed |
| | | | | | at 38° C. |
| Example 3 | 9.8 × 10⁶ | 78° C./30 s, | No | 9.8 × 10⁶ | Stable for |
| | | 65° C./600 s | logarithmic | | 6 months |
| | | | reduction | | at 10° C. |
| | | | | | and 28° C.; |
| | | | | | reduction |
| | | | | | of 5 log |
| | | | | | cfu/ml |
| | | | | | observed |
| | | | | | at 38° C. |
| Example 4 | 7.9 × 10⁶ | 78° C./30 s, | No | 7.9 × 10⁶ | Stable for |
| | | 72° C./180 s | logarithmic | | 6 months |
| | | | reduction | | at 10° C. |
| | | | | | and 28° C.; |
| | | | | | reduction |
| | | | | | of 5 log |
| | | | | | cfu/ml |
| | | | | | observed |
| | | | | | at 38° C. |
| Comp. | 7.6 × 10⁶ | 110° C./30 s | No surviving | 0 | — |
| Example 1 | | | strains | | |
| Comp. | 8.6 × 10⁶ | 110° C./30 s | No surviving | 0 | — |
| Example 2 | | | strains | | |

The above test results show that for an acidic beverage produced via the method provided in the present invention, contaminant bacteria can be fully eliminated while at the same time satisfying international standards for the number of Bacillus coagulans contained therein, and the two-step sterilization method can effectively maintain the stability of the acidic beverage and extend the shelf-life of the acidic beverage without affecting the flavor and texture of the acidic beverage. The invention also provides an acidic beverage prepared via said addition method, wherein said beverage has a favorable texture and good stability and can be stored on a shelf at room temperature for at least 6 months. It should be apparent that the aforementioned examples pertaining to the present invention are merely illustrative of the present invention and are not intended to limit the scope of embodiments of the present invention; persons skilled in the art may make various changes and modifications to the above description and an exhaustive list of embodiments cannot be provided here. Any obvious changes or modifications made to the technical solution constituted by the present invention shall fall within the protective scope of the present invention.

1. A method for the production of a room-temperature acidic beverage containing sporic Bacillus coagulans, which is characterized in that is comprises the following steps:
An acidic beverage is prepared and sterilized under sterilization conditions corresponding to 75° C. to 110° C. for 23 to 33 s;
Sporic Bacillus coagulans is then dispersed into sterile water, and the Bacillus coagulans solution thus obtained is pasteurized under pasteurization conditions corresponding to 70 to 90° C. for 23 to 33 s;
The acidic beverage obtained following sterilization and the sporic Bacillus coagulans solution obtained following pasteurization are placed in canned packaging to obtain a room-temperature acidic beverage containing sporic Bacillus coagulans.

2. A method for the production of a room-temperature acidic beverage as specified in claim 1, which is characterized in that said room-temperature acidic beverage includes room-temperature yogurt, juice, flavored water, a juice-based tea beverage or a sports beverage.

3. A method for the production of a room-temperature acidic beverage as specified in claim 1, which is characterized in that the pH value of said room-temperature acidic beverage ranges from 2.0 to 4.4, where the pH value of said room-temperature acidic beverage should preferably range from 3.7 to 4.3.

4. A method for the production of a room-temperature acidic beverage as specified in claim 1, which is characterized in that the initial concentration of sporic Bacillus coagulans added to said room-temperature acidic beverage corresponds to 1×10⁷ cfu/ml, and the concentration of sporic Bacillus coagulans does not fall under 10⁶ cfu/ml within 6 months at a temperature of 28° C.

5. A method for the production of a room-temperature acidic beverage as specified in claim 1, which is characterized in that pasteurization of the Bacillus coagulans solution is performed at 75 to 78° C. for 27 to 33 s.

6. A method for the production of a room-temperature acidic beverage as specified in claim 1, which is characterized in that the method used to place the acidic beverage obtained following pasteurization and the sporic Bacillus coagulans solution into canned packaging includes sterile filling or hot filling.

7. A method for the production of a room-temperature acidic beverage as specified in claim 6, which is characterized in that in said sterile filling method the acidic beverage obtained following sterilization and the sporic Bacillus coagulans solution obtained following pasteurization were subject to in-line mixing.

8. A method for the production of a room-temperature acidic beverage as specified in claim 6, which is characterized in that said hot filling method is performed at a filling temperature of 70 to 88° C. and a double filling machine is used to place the acidic beverage obtained following sterilization and the sporic Bacillus coagulans solution obtained following pasteurization into canned packaging.

9. A method for the production of a room-temperature acidic beverage as specified in claim 8 which is characterized in that the method used for the production of said room-temperature acidic beverage also involves performing in-container pasteurization following hot filling, where sterilization is performed at 72° C. for 180 s or 65° C. for 600 s.

10. A room-temperature acidic beverage containing sporic Bacillus coagulans, which is characterized in that it is prepared via a method for the production of a room-temperature acidic beverage as specified in any one of claim 1.
